(19) United States
(12) Patent Application Publication
(10) Pub. No.: US 2026/0341994 A1
(43) Pub. Date: Oct. 29, 2026

(54) Connector and Connector Assembly

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Jiaoyong (Mac) Liu, Shanghai (CN); Jie (Roger) Luo, Foshan (CN); Rong(Summer) Zhang, Shenzhen (CN); Matthew Ryan SCHMITT, Middletown, PA (US); William (Wei) Yao, Kunshan (CN); Huakun (Walker) Wei, Dongguan (CN); Durgesh Panchal, Bangalore (IN)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 19/661,938

(22) Filed: Apr. 29, 2026

(30) Foreign Application Priority Data
Apr. 29, 2025 (CN) 202510559136.4

(51) Int. Cl. H01R 13/115; H01R 13/03; H01R 13/04; H01R 13/18; H01R 13/436; H01R 13/506

(52) U.S. Cl. CPC H01R 13/115; H01R 13/03; H01R 13/04; H01R 13/18; H01R 13/4361; H01R 13/506

(57) ABSTRACT

A connector comprises a housing, and a terminal assembly installed in the housing and including at least one terminal. The at least one terminal includes an elastic part, a connection part and an installation part. The elastic part is located at one end of the terminal and is adapted to electrically contact a mating terminal. The connection part is located at another end of the terminal and is adapted to electrically connect to an electrical transmission component. The installation part is located between the elastic part and the connection part and is bent into a predetermined shape.

### CROSS-REFERENCE TO RELATED APPLICATION

This application claims the benefit of Chinese Patent Application No. CN202510559136.4 filed on Apr. 29, 2025, in the State Intellectual Property Office of China, the whole disclosure of which is incorporated herein by reference.

### FIELD OF THE INVENTION

The present invention relates to a connector, particularly to a power connector. The present invention also relates to a connector assembly comprising the connector.

### BACKGROUND OF THE INVENTION

In the prior art, a power connector typically includes a housing and terminals located within the housing. In the prior art, a contact area of an elastic part of the terminal of the existing connector is relatively small, the contact resistance is high, and it cannot carry large current. In addition, in the prior art, for ease of installation, the housing is usually an integrated injection molded part and a terminal socket is formed in the housing along its longitudinal direction. The terminal extends along the longitudinal direction of the housing and is inserted into the terminal socket of the housing along the longitudinal direction of the housing. The existing connectors cannot achieve a curved current path, which limits their application range in situations where space is limited.

### SUMMARY OF THE INVENTION

According to an embodiment of the present disclosure, a connector comprises a housing, and a terminal assembly installed in the housing and including at least one terminal. The at least one terminal includes an elastic part, a connection part and an installation part. The elastic part is located at one end of the terminal and is adapted to electrically contact a mating terminal. The connection part is located at another end of the terminal and is adapted to electrically connect to an electrical transmission component. The installation part is located between the elastic part and the connection part and is bent into a predetermined shape.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of a connector according to an exemplary embodiment of the present invention when viewed from the top;

FIG. 3 shows an illustrative exploded view of a connector according to an exemplary embodiment of the present invention when viewed from the bottom;

FIG. 4 shows a cross-sectional view of a connector according to an exemplary embodiment of the present invention;

FIG. 5 shows an illustrative perspective view of a terminal assembly of a connector according to an exemplary embodiment of the present invention;

FIG. 6 shows a cross-sectional view of a terminal assembly of a connector according to an exemplary embodiment of the present invention;

FIG. 7 shows an illustrative exploded view of a terminal assembly of a connector according to an exemplary embodiment of the present invention;

FIG. 8 shows an illustrative perspective view of a connector and mating terminal according to an exemplary embodiment of the present invention, where the plug part of the connector has not yet been inserted into the slot of the mating terminal;

FIG. 9 shows a cross-sectional view of a connector and mating terminal according to an exemplary embodiment of the present invention, wherein the plug part of the connector has not yet been inserted into the slot of the mating terminal;

FIG. 10 shows a cross-sectional view of a connector and mating terminal according to an exemplary embodiment of the present invention, wherein the plug part of the connector has been inserted into the slot of the mating terminal; and

FIG. 11 shows an illustrative perspective view of a connector according to an exemplary embodiment of the present invention, wherein an electrical transmission component is shown.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector comprises a housing, and a terminal assembly installed in the housing and comprising at least one terminal. The terminal has: an elastic part located at one end of the terminal for electrical contact with a mating terminal; a connection part located at the other end of the terminal, used for electrical connection to an electrical transmission component; and an installation part which is located between the elastic part and the connection part and is bent into a predetermined shape.

According to embodiment of the present disclosure, a connector assembly is provided. The connector assembly comprises the above connector, and a mating terminal mated with the connector. The mating terminal has two opposite ends in the longitudinal direction and two opposite sides in the transverse direction, two slots extending along the height direction are formed at each end of the mating terminal, so that the cross-section of the mating terminal perpendicular to the height direction is in a “ [symbol] ” shape, the elastic part of the terminal of the connector is accommodated in the slot of the mating terminal and electrically contacts the inner wall surface of the slot of the mating terminal.

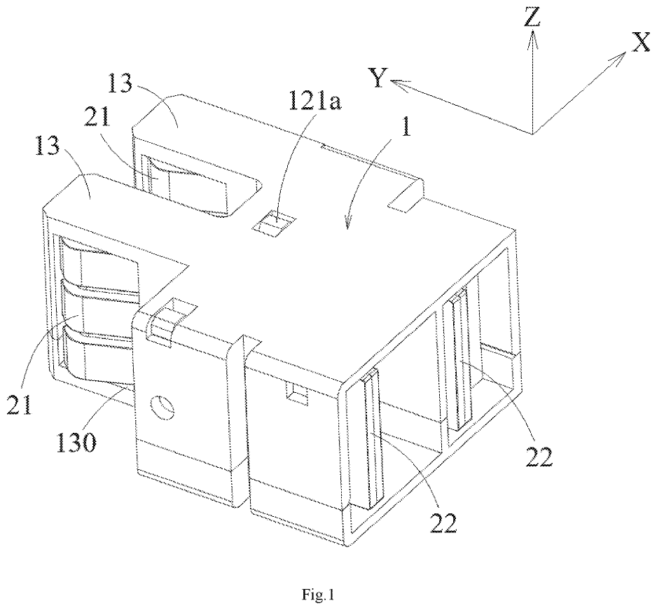

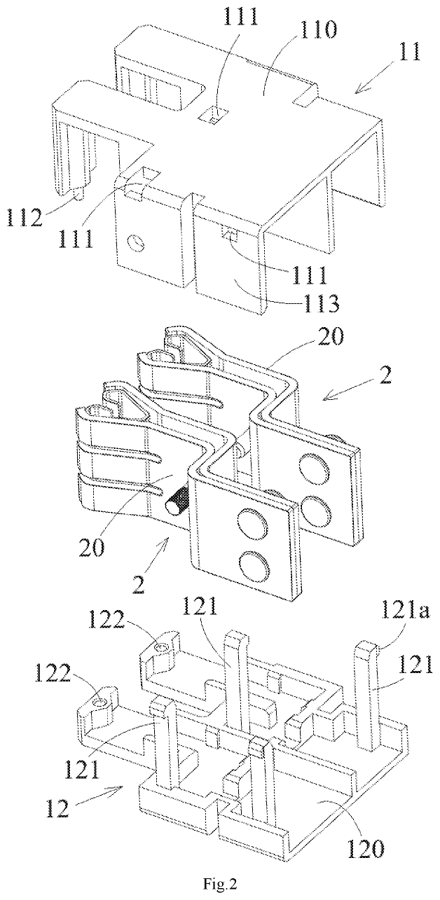

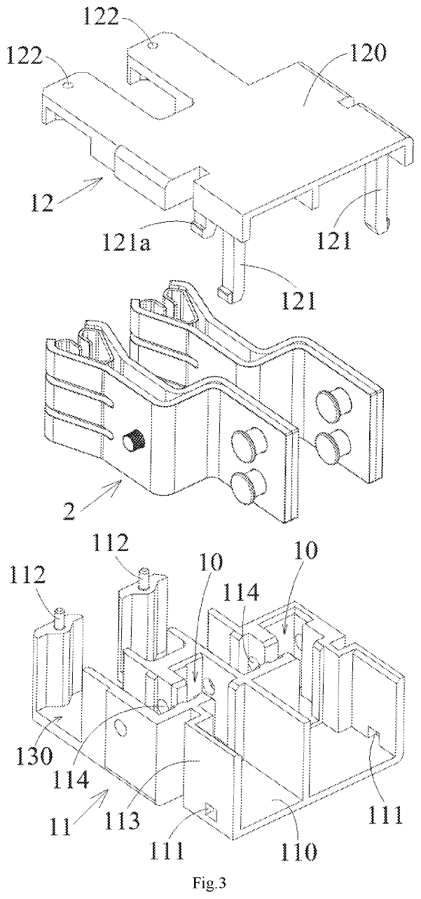

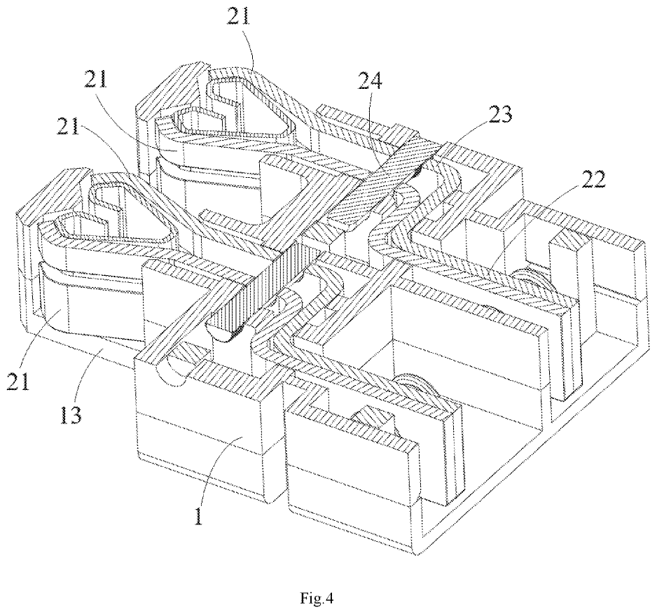

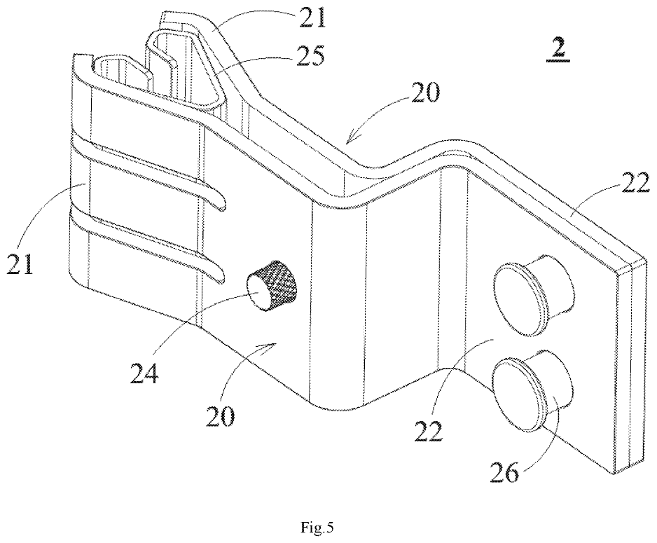

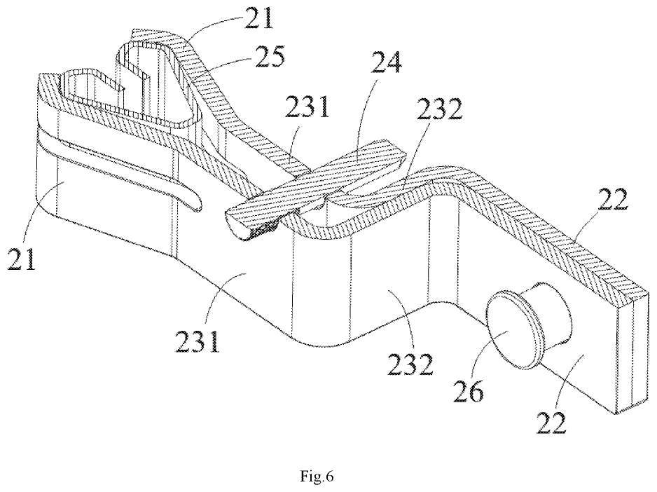

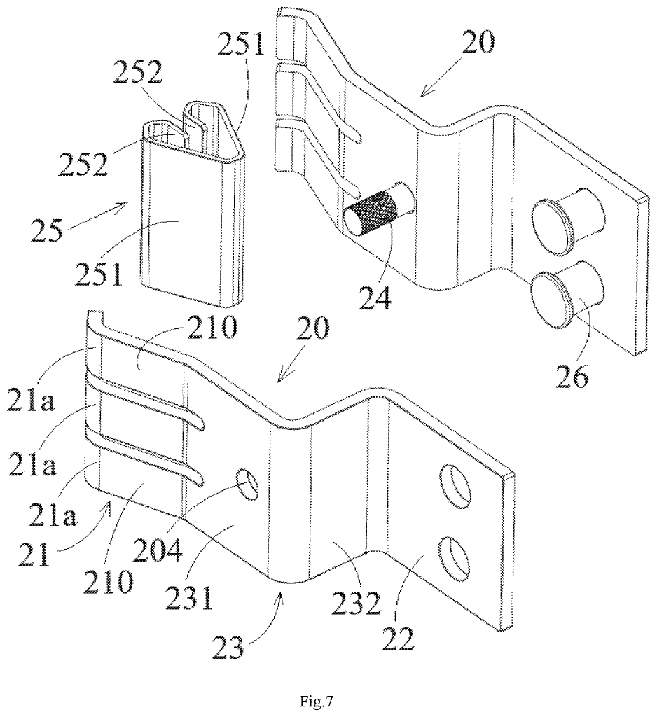

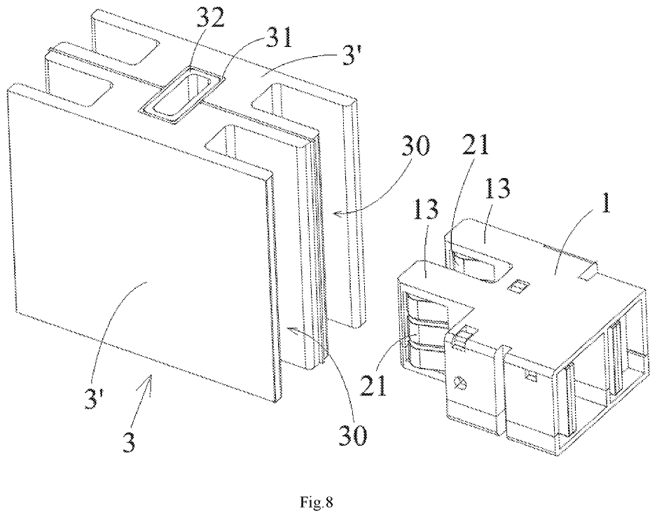

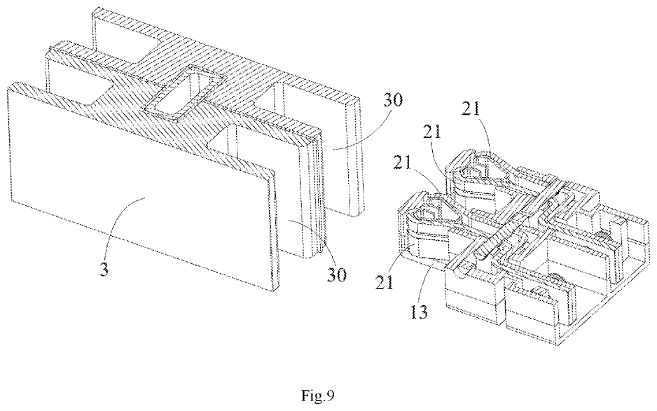

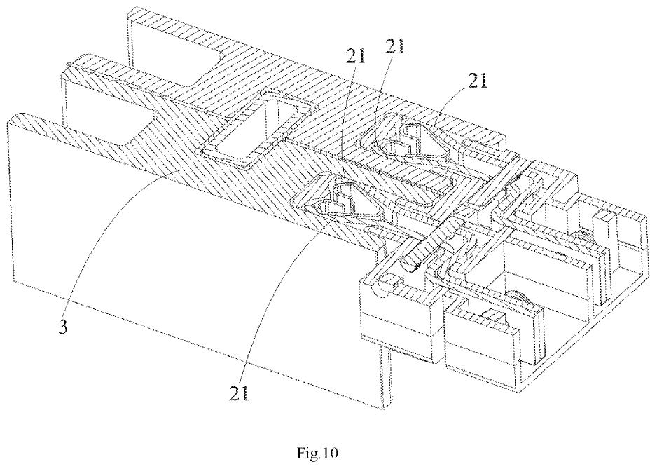

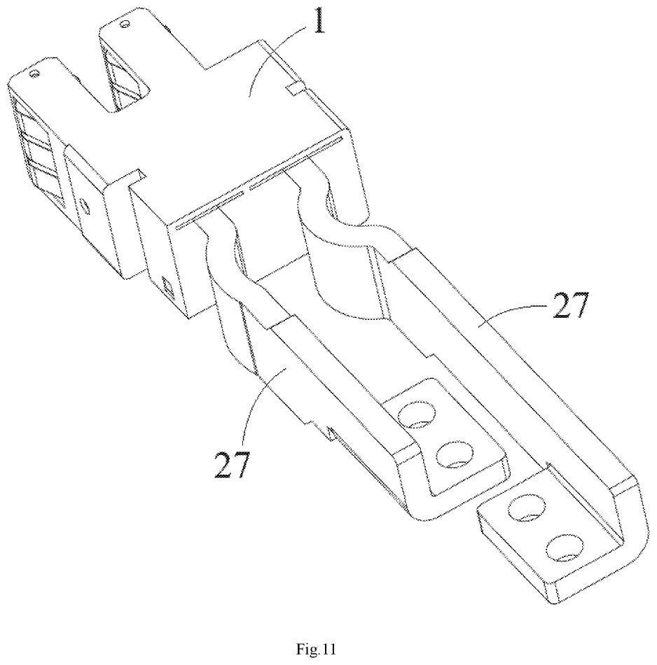

FIG. 1 shows an illustrative perspective view of a connector according to an exemplary embodiment of the present invention. FIG. 2 shows an illustrative exploded view of a connector according to an exemplary embodiment of the present invention when viewed from the top. FIG. 3 shows an illustrative exploded view of a connector according to an exemplary embodiment of the present invention when viewed from the bottom. FIG. 4 shows a cross-sectional view of a connector according to an exemplary embodiment of the present invention. FIG. 5 shows an illustrative perspective view of a terminal assembly 2 of a connector according to an exemplary embodiment of the present invention. FIG. 6 shows a cross-sectional view of a terminal assembly 2 of a connector according to an exemplary embodiment of the present invention. FIG. 7 shows an illustrative exploded view of a terminal assembly 2 of a connector according to an exemplary embodiment of the present invention. FIG. 8 shows an illustrative perspective view of a connector and mating terminal 3 according to an exemplary embodiment of the present invention, where the plug part 13 of the connector has not yet been inserted into the slot 30 of the mating terminal 3. FIG. 9 shows a cross-sectional view of a connector and mating terminal 3 according to an exemplary embodiment of the present invention, where the plug part 13 of the connector has not yet been inserted into the slot 30 of the mating terminal 3. FIG. 10 shows a cross-sectional view of a connector and mating terminal 3 according to an exemplary embodiment of the present invention, wherein the plug part 13 of the connector has been inserted into the slot 30 of the mating terminal 3. FIG. 11 shows an illustrative perspective view of a connector according to an exemplary embodiment of the present invention, in which an electrical transmission component 27 is shown.

As shown in FIGS. 1-11, in an exemplary embodiment of the present disclosure, a connector includes a housing 1 and a terminal assembly 2. The housing 1 includes an upper housing 11 and a lower housing 12 that are suitable for assembly together. The terminal assembly 2 is installed in the housing 1 and includes a pair of terminals 20. The terminal 20 has an elastic part 21, a connection part 22, and an installation part 23. The elastic part 21 is located at one end of the terminal 20 and is used to make electrical contact with a mating terminal 3. The connection part 22 is located at the other end of the terminal 20 and is used for electrical connection to an electrical transmission component 27. The installation part 23 is located between the elastic part 21 and the connection part 22 and is bent into a predetermined shape. The installation parts 23 of the pair of terminals 20 are floatingly mounted in the housing 1, so that the elastic parts 21 and the connection parts 22 of the pair of terminals 20 can float relative to the housing 1. In this way, it can absorb certain installation and manufacturing errors, facilitating installation and electrical connection operations.

In the illustrated embodiment, the installation part 23 of the terminal 20 includes a first extension part 231 and a second extension part 232. The first extension part 231 extends along the longitudinal direction Y of the housing 1. The second extension part 232 extends along the transverse direction X of the housing 1. One end of the second extension part 232 is vertically connected to the rear end of the first extension part 231, so that the installation part 23 of the terminal 20 is L-shaped. In the illustrated embodiment, both the first extension part 231 and the second extension part 232 have a flat plate shape. The elastic part 21 of the terminal 20 is connected to the front end of the first extension part 231 of the installation part 23. The connection part 22 of the terminal 20 is connected to the other end of the second extension part 232 of the installation part 23.

In the illustrated embodiment, the terminal 20 is an integral stamped part. This can reduce manufacturing costs and improve manufacturing efficiency.

The first extension parts 231 of the pair of terminals 20 are spaced apart by a predetermined distance in the transverse direction X of the housing 1, and the second extension parts 232 of the pair of terminals 20 are pressed against each other in the longitudinal direction Y of the housing 1.

A through hole 204 is formed in the first extension part 231 of the terminal 20, and an installation hole 114 corresponding to the through hole 204 is formed in the side wall of the housing 1. The terminal assembly 2 also includes a positioning pin 24, which passes through the through holes 204 in the first extension parts 231 of the pair of terminals 20. The two ends of the positioning pin 24 are respectively inserted into the installation holes 114 in the two side walls of the housing 1.

The housing 1 has a plug part 13 suitable for insertion into a slot 30 of the mating terminal 3, and the plug part 13 has two opposite side openings 130 in the transverse direction X. The elastic parts 21 of the pair of terminals 20 are installed in the plug part 13 of the housing 1 and are respectively exposed from the two side openings 130, for electrical contact with the inner wall surface of the slot 30 of the mating terminal 3.

The elastic part 21 of the terminal 20 has multiple elastic cantilevers 210 arranged in a row in the height direction Z of the housing 1, and the elastic cantilevers 210 have contact protrusions 21a protruding from the side openings 130 of the plug part 13. The contact protrusions 21a of the pair of terminals 20 are in electrical contact with the two inner wall surfaces of the slot 30 of the mating terminal 3, respectively.

The terminal assembly 2 further comprises an elastic support member 25, which is clamped between the elastic parts 21 of the pair of terminals 20. The elastic support member 25 is used to apply auxiliary contact force to the elastic parts 21 of the pair of terminals 20 to ensure reliable electrical contact between the elastic parts 21 of the pair of terminals 20 and the inner wall surface of the slot 30 of the mating terminal 3.

The elastic support member 25 includes a pair of support arms 251. The rear ends of a pair of support arms 251 are connected, and the front ends of the pair of support arms 251 are respectively pressed against the inner sides of the elastic parts 21 of the pair of terminals 20. The pair of support arms 251 form a V-shaped support structure that opens from back to front.

The elastic support member 25 further includes a pair of end arms 252. The pair of end arms 252 are respectively connected to the front ends of a pair of support arms 251 and bent backwards relative to the front ends of the pair of support arms 251. The pair of end arms 252 are located between the front ends of the pair of support arms 251 and are adapted to rest against each other for supporting the pair of support arms 251.

In the illustrated embodiment, the elastic support member 25 is an integral stamped part. This can reduce manufacturing costs and improve manufacturing efficiency.

The mechanical properties of the manufacturing material of the elastic support member 25 are superior to those of the manufacturing material of the terminal 20. The conductivity of the material used to manufacture terminal 20 is superior to that of the material used to manufacture elastic support member 25. For example, the terminal 20 is made of copper or copper alloy, and the elastic support member 25 is made of stainless steel. However, the present invention is not limited to the illustrated embodiments. For example, the terminal 20 and the elastic support member 25 may also be made of the same conductive material, such as copper or copper alloy.

The connection parts 22 of the pair of terminals 20 is plate-shaped and stacked and connected together, and the connection parts 22 of the pair of terminals 20 is suitable for being electrically connected to an electrical transmission member 27. The connection parts 22 of the pair of terminals 20 are adapted to be riveted, welded, or crimped to the electrical transmission member 27 for electrical connection with the electrical transmission member 27.

The connector further comprises an electrical transmission member 27, which is connected to the connection parts 22 of the pair of terminals 20 and leads out from the rear end of the housing 1. The terminal assembly 2 further includes a rivet post 26 that passes through the connection parts 22 of the pair of terminals 20 and the electrical transmission member 27. The rivet post 26 is used to rivet the connection parts 22 of the pair of terminals 20 and the electrical transmission member 27 together.

The electrical transmission component 27 is a busbar, and the connection parts 22 of the pair of terminals 20 are electrically connected to one end of the busbar. However, the present invention is not limited to the illustrated embodiment. For example, in another exemplary embodiment of the present invention, the electrical transmission member 27 may be a cable (not shown) with a flat connection end, and the connection parts 22 of the pair of terminals 20 are electrically connected to the flat connection end of the cable.

The connector comprises two terminal assemblies 2, and two separate installation chambers 10 are formed in the housing 1. The two terminal assemblies 2 are respectively installed in the two installation chambers 10 of the housing 1 and arranged side by side in the transverse direction X of the housing 1. An installation chamber 10 is formed in the upper housing 11, and the terminal assembly 2 is adapted to be installed into the installation chamber 10 through a bottom opening of the upper housing 11. The lower housing 12 is suitable for being detachably assembled onto the bottom of the upper housing 11 to cover the bottom opening of the upper housing 11.

The lower housing 12 has a bottom plate 120 and multiple elastic buckles 121 connected to the bottom plate 120, and a hook 121a is formed at the end of the elastic buckle 121. Multiple slots 111 are formed on a side plate 113 and/or top plate 110 of the upper housing 11, and the hooks 121a of the multiple elastic buckles 121 are respectively engaged with the multiple slots 111 to lock the upper housing 11 and the lower housing 12 together.

Multiple positioning columns 112 are formed at the bottom of the side plate 113 of the upper housing 11, and multiple positioning holes 122 are formed in the lower housing 12. The multiple positioning columns 112 are respectively inserted into the multiple positioning holes 122 to position the lower housing 12 on the bottom of the upper housing 11.

Still referring to FIGS. 1-11, in another exemplary embodiment of the present invention, a connector assembly is also disclosed. The connector assembly includes the aforementioned connector and a mating terminal 3. The mating terminal 3 is mated with the connector. The mating terminal 3 has two opposite ends in the longitudinal direction Y and two opposite sides in the transverse direction X. Two slots 30 extending along the height direction Z are formed at each end of the mating terminal 3, so that the cross-section of the mating terminal 3 perpendicular to the height direction Z is in a “ [symbol] ” shape. The elastic part 21 of the terminal 20 of the connector is accommodated in the slot 30 of the mating terminal 3 and electrically contacts the inner wall surface of the slot 30 of the mating terminal 3. A groove 31 is formed in the middle of the mating terminal 3 for accommodating a heat dissipation component 32 to dissipate heat from the mating terminal 3. The heat dissipation component 32 may be a liquid cooling component or other suitable heat dissipation component. In the illustrated embodiment, the mating terminal 3 includes two H-shaped sub mating terminals 3′ combined together, and the two H-shaped sub mating terminals 3′ are electrically isolated from each other.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing; and
a terminal assembly installed in the housing and including at least one terminal, the at least one terminal comprising:
an elastic part located at one end of the terminal and adapted to electrically contact a mating terminal;
a connection part located at an opposite end of the terminal and adapted to electrically connect to an electrical transmission component; and
an installation part arranged between the elastic part and the connection part and bent into a predetermined shape.

2. The connector according to claim 1, wherein the installation part of the terminal is movably installed in the housing, so that the elastic part and connection part of the terminal can float relative to the housing.

3. The connector according to claim 1, wherein the installation part of the terminal comprises:
a first extension part extending along a longitudinal direction of the housing; and
a second extension part extending along a transverse direction of the housing, one end of the second extension part connected to a rear end of the first extension part.

4. The connector according to claim 3, wherein the elastic part of the terminal is connected to a front end of the first extension part of the installation part, and the connection part of the terminal is connected to an opposite end of the second extension part of the installation part.

5. The connector according to claim 4, wherein the terminal is an integral stamped part.

6. The connector according to claim 4, wherein the terminal assembly includes a pair of terminals, the first extension parts of the pair of terminals are spaced apart from each other by a predetermined distance in the transverse direction of the housing, and the second extension parts of the pair of terminals are pressed against each other in the longitudinal direction of the housing.

7. The connector according to claim 6, wherein:
a through hole is formed in the first extension part of the terminal, and an installation hole corresponding to the through hole is formed in the side wall of the housing; and
the terminal assembly further comprises a positioning pin passing through the through holes in the first extension parts of the pair of terminals, two ends of the positioning pin are respectively inserted into the installation holes in two side walls of the housing.

8. The connector according to claim 1, wherein the housing has a plug part adapted to be inserted into a slot of the mating terminal, the plug part having two opposite side openings in the transverse direction, the terminal assembly comprises a pair of terminals, and the elastic parts of the pair of terminals are installed in the plug part of the housing and exposed from the two side openings respectively, for electrical contact with the inner wall surface of the slot of the mating terminal.

9. The connector according to claim 8, wherein the elastic part of the terminal has multiple elastic cantilevers arranged in a row in a height direction of the housing, and the elastic cantilevers have contact protrusions protruding from the side opening of the plug part, the contact protrusions of the pair of terminals are in electrical contact with the two inner wall surfaces of the slot of the mating terminal, respectively.

10. The connector according to claim 8, wherein the terminal assembly further comprises an elastic support member clamped between the elastic parts of the pair of terminals, the elastic support member adapted to apply auxiliary contact force to the elastic parts of the pair of terminals to ensure reliable electrical contact between the elastic parts of the pair of terminals and the inner wall surface of the slot of the mating terminal.

11. The connector according to claim 10, wherein the elastic support member comprises a pair of support arms, with rear ends thereof connected and front ends thereof respectively resting on the inner sides of the elastic parts of the pair of terminals, wherein the pair of support arms form a V-shaped support structure that opens from the back to the front.

12. The connector according to claim 11, wherein the elastic support member further comprises a pair of end arms respectively connected to the front ends of the pair of support arms and bent backwards relative to the front ends of the pair of support arms, the pair of end arms are arranged between the front ends of the pair of support arms and are adapted to rest against each other for supporting the pair of support arms.

13. The connector according to claim 12, wherein the elastic support member is an integral stamped part.

14. The connector according to claim 10, wherein:
a material of the elastic support member has a higher yield strength that a material of the terminal; and
a conductivity of a material of the terminal is greater than that of a material of the elastic support member.

15. The connector according to claim 14, wherein the terminal is made of copper or copper alloy, and the elastic support member is made of stainless steel.

16. The connector according to claim 10, wherein the connection parts of the pair of terminals are plate-shaped and stacked and connected together, and the connection parts of the pair of terminals are adapted to be electrically connected to the electrical transmission component.

17. The connector according to claim 16, wherein the connection parts of the pair of terminals are adapted to be riveted, welded or crimped onto the electrical transmission component for electrical connection with the electrical transmission component.

18. The connector according to claim 16, further comprising an electrical transmission component connected to the connection parts of the pair of terminals and led out from the rear end of the housing.

19. The connector according to claim 18, wherein the terminal assembly further comprises a riveting post passing through the connection parts of the pair of terminals and the electrical transmission component, the riveting post riveting the connection parts of the pair of terminals and the electrical transmission component together.

20. The connector according to claim 18, wherein:
the electric transmission component is a busbar, and the connection parts of the pair of terminals are electrically connected to one end of the busbar; or
the electric transmission component is a cable with a flat connection end, and the connection parts of the pair of terminals are electrically connected to the flat connection end of the cable.

21. The connector according to claim 1, wherein the connector comprises two terminal assemblies, with two separate installation chambers formed in the housing, the two terminal assemblies are respectively installed in the two installation chambers of the housing and arranged side by side in the transverse direction of the housing.

22. The connector according to claim 1, wherein:
the housing comprises an upper housing and a lower housing adapted to be assembled together, and an installation chamber is formed in the upper housing; the terminal assembly is adapted to be installed into the installation chamber through a bottom opening of the upper housing; and
the lower housing is adapted to be detachably assembled onto the bottom of the upper housing to cover the bottom opening of the upper housing.

23. The connector according to claim 22, wherein:
the lower housing has a bottom plate and multiple elastic buckles connected to the bottom plate, and a hook is formed at the end of the elastic buckle; and
multiple slots are formed on a side plate and/or top plate of the upper housing, and the hooks of the multiple elastic buckles are respectively engaged with the multiple slots to lock the upper housing and the lower housing together.

24. The connector according to claim 23, wherein multiple positioning columns are formed at the bottom of the side plate of the upper housing, and multiple positioning holes are formed in the lower housing, the multiple positioning columns are respectively inserted into the multiple positioning holes to position the lower housing on the bottom of the upper housing.

25. A connector assembly, comprising:
the connector according to claim 1; and
a mating terminal mated with the connector,
wherein the mating terminal has two opposite ends in the longitudinal direction and two opposite sides in the transverse direction, two slots extending along the height direction are formed at each end of the mating terminal, so that the cross-section of the mating terminal perpendicular to the height direction is in a “ [symbol] ” shape,
wherein the elastic part of the terminal of the connector is accommodated in the slot of the mating terminal and electrically contacts the inner wall surface of the slot of the mating terminal.

26. The connector assembly according to claim 25, wherein a groove for accommodating a heat dissipation component is formed in the middle of the mating terminal to dissipate heat from the mating terminal.

27. The connector assembly according to claim 26, wherein the heat dissipation component is a liquid cooled component.

28. The connector assembly according to claim 26, wherein the mating terminal comprises two H-shaped sub mating terminals combined together, and the two H-shaped sub mating terminals are electrically isolated from each other.
